(19) United States
(12) Patent Application Publication
(10) Pub. No.: US 2015/0245626 A1
(43) Pub. Date: Sep. 3, 2015

(54) WHOLE GRAIN PRETZEL PRODUCT

(71) Applicant: MOM Brands Company, Lakeville, MN (US)

(72) Inventors: David Klaus Duffy, Maple Grove, MN (US); Matthew John Engel, Lakeville, MN (US)

(21) Appl. No.: 14/625,428

(22) Filed: Feb. 18, 2015

Related U.S. Application Data
(60) Provisional application No. 61/946,448, filed on Feb. 28, 2014.

(51) Int. Cl. A21D 13/00; A21D 8/02

(52) U.S. Cl. CPC A21D 13/0061; A21D 8/02

(57) ABSTRACT

A baked food product comprising a layered assembly and methods of making the baked food product are disclosed. The layered assembly comprises a top whole grain layer and a bottom whole grain layer. Each whole grain layer comprises a plurality of shredded whole grain strands. The assembly includes a first exterior surface defined by the top whole grain layer and a second exterior surface defined by the bottom whole grain layer. One or more of the exterior surfaces of the assembly is treated with a salt solution and the treated surface comprises a nonenzymatic browning portion formed by a Maillard reaction during baking of the product. The layered assembly can include one or more middle whole grain layers and can be in a biscuit form.

### CROSS-REFERENCE TO RELATED APPLICATIONS

This application claims the benefit of U.S. Provisional Application Ser. No. 61/946,448, filed Feb. 28, 2014, entitled “Whole Grain Pretzel Product,” which is incorporated by reference herein in its entirety.

### BACKGROUND

Pretzels are a type of baked bread product that are a popular snack food enjoyed by many consumers. Pretzels can be provided in hard or soft forms. Soft pretzels have a soft, cooked, doughy interior with a browned skin. Hard pretzels are baked such that the entire food product has a crisp, crunchy profile. Similar to soft pretzels, hard pretzels include the browned skin characteristic of a pretzel. Traditionally pretzels have been provided in a knot or stick form. Recently, pretzels have been produced as thin wafers and as pretzel-cracker hybrids.

Pretzels are generally made from enriched white flour and therefore have little nutritional value. As consumers become more health conscious, there is a demand for pretzel-like products that provide greater nutritional benefits to the consumer than traditional pretzel products. A food product providing the health and nutritional benefits of whole grains and the taste and texture characteristics of a pretzel would be desirable.

### SUMMARY

In general terms, this disclosure is directed to a baked food product comprising a layered assembly. The food product comprises a plurality of whole grain layers, including a top whole grain layer, a bottom whole grain layer, and in some embodiments, one or more middle layers, wherein each layer includes a plurality of shredded whole grain strands. A first exterior surface is defined by the top whole grain layer and a second exterior surface is defined by the bottom whole grain layer. At least one exterior surface is treated with a salt solution, such as sodium hydroxide or sodium bicarbonate solutions, prior to baking. The salt solution increases the pH of the exterior surface of the wheat strands and induces a Maillard reaction at the treated surface during baking, producing melanoidins. The treated surface comprises nonenzymatic browning portions formed by the Maillard reaction.

In another aspect, a method for producing a baked food product includes producing a shredded wheat strand, producing a layer comprising a plurality of shredded wheat strands, treating at least one layer with a salt solution, applying salt to at least one layer, producing a food product comprising a plurality of layers of shredded wheat strands, and baking the food product.

In another aspect, a layered assembly includes a plurality of layers of shredded wheat strands, wherein the shredded wheat strands are produced by cooking and tempering whole grain wheat berries, which are then shredded and used to form the layers. At least one layer is salted and a sodium hydroxide solution, or other salt solution, is applied to at least one layer of shredded wheat strands. The layers are then baked and the Maillard reaction produces melanoidins on the surface of the wheat strands treated with sodium hydroxide.

### BRIEF DESCRIPTION OF THE DRAWINGS

FIG. 1 illustrates a top view of an example layered assembly with whole grain shreds aligned substantially latitudinally.

FIG. 2 illustrates a cross-sectional view of an example layered assembly with whole grain shreds aligned substantially latitudinally.

FIG. 3 illustrates a top view of an example elongated layered assembly with whole grain shreds aligned substantially longitudinally.

FIG. 4 illustrates a perspective view of an example elongated layered assembly.

FIG. 5 illustrates an example general process diagram for producing a shredded whole grain pretzel product.

FIG. 6 illustrates an example process diagram showing the steps for producing a shredded whole grain pretzel product.

### DETAILED DESCRIPTION

Many consumers desire snack products made with whole grains rather than processed or refined grains because the whole grain products provide greater health and nutritional benefits. A whole grain pretzel product having the crispy, crunchy profile characteristic of hard pretzels is disclosed. The product of the disclosure provides a healthy alternative to conventional pretzels, providing a good source of fiber and the health and nutritional benefits of whole grains.

The whole grain pretzel product of the disclosure comprises shreds of whole grains, including but not limited to wheat, corn, rye, barley and oats, and a browned exterior that provides a flavor profile characteristic of a hard pretzel. In an embodiment, the whole grain shreds comprise shredded wheat berries. The whole grain pretzel product typically includes a plurality of shredded whole grain layers to provide a layered assembly. In embodiments, the layered assembly has a biscuit or bar form. Each layer includes a plurality of whole grain shreds, alternatively referred to herein as whole grain strands. The exterior surface of the product has a browned exterior, similar to the browned skin of a conventional hard pretzel, and provides the product with a pretzel-like appearance and taste.

Many of the flavors and aromas associated with pretzels are attributed to the Maillard reaction, a set of reactions that causes nonenzymatic browning of food. A description of the reaction pathways and products of the Maillard reaction can be found, for example, in The Maillard Reaction: Chemistry, Biochemistry, and Implications, Royal Society of Chemistry, H. E. Nursten (2005) and Fennema's Food Chemistry, Fourth Edition, Damodaran, Parkin, and Fenema (eds.), 2007. The Maillard reaction results from a chemical reaction between an amino acid and a reducing sugar. In pretzels, heat acts as a catalyst inducing the reaction of reducing sugars with free amino groups of proteins in the shredded whole grain, forming a number of compounds including glycosylamine. The glycosylamine undergoes a reaction called the Amadori rearrangement, forming reactive cyclic compounds. These reactive cyclic compounds polymerize at pHs greater than about 5 to form insoluble, dark-colored, nitrogenous polymers and copolymers called melanoidins, which are believed to provide the deep brown color and flavor profile that is characteristic of pretzels. Aroma and other flavor compounds are also produced as a result of the Maillard reaction.

As described herein, the exterior surface of the product is treated with a salt solution prior to baking the product. The salt solution increases the pH of the exterior surface of the product during baking, inducing a Malliard browning reaction at the treated surface to provide the browned exterior. Although not wishing to be bound by a particular theory, it is believed that the browned exterior of the whole grain pretzel product of the disclosure comprises melanoidins, which are formed during nonenzymatic browning of the product and contribute to the flavor of the product having a flavor profile characteristic of a pretzel. Because the product is made with whole grain shreds, the product comprises a higher surface area to volume ratio than conventional pretzel products, thereby providing a greater surface area for Maillard browning and providing consumers more pretzel flavoring in each bite of the product. Thus, the whole grain pretzel product of the disclosure provides a healthy snack with the health and nutritional benefits of whole grains capable of providing pretzel flavor that can be more intense per volume compared to conventional pretzel products.

Exemplary embodiments of the whole grain pretzel products of the disclosure and methods for making are described herein with reference to the figures. Reference to various embodiments does not limit the scope of the claims attached hereto. Additionally, any examples set forth in this specification are not intended to be limiting and merely set forth some of the many possible embodiments for the appended claims.

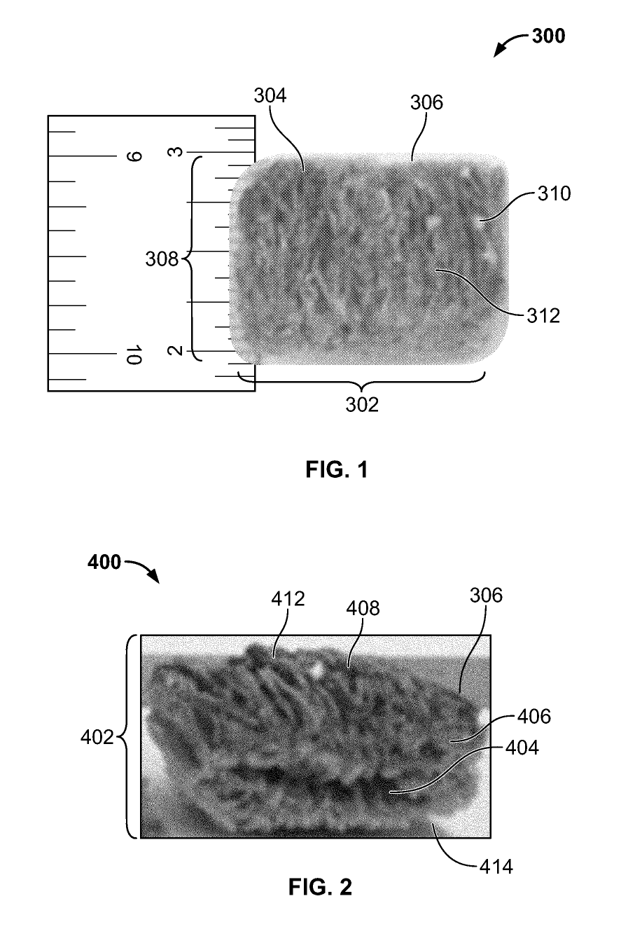

FIG. 1 is a top view 300 of an example shredded whole grain pretzel product 306. In this embodiment, the shredded whole grain comprises wheat berries. Other suitable grains include, but are not limited to, corn, rye, barley, oats, and combinations thereof. The product comprises a layered assembly 306 having a plurality of shredded whole grain layers. The layered assembly 306 can be provided in a biscuit form as shown in FIGS. 1-4. As used herein, the term “biscuit” is not intended to be limiting in any sense. Rather, biscuit is only used to convey a grain-based product that is baked, toasted, or both. No particular limiting geometric shape should be applied to “biscuit form”. The biscuit can be provided in various geometric shapes, including, but not limited to, squares, rectangles, triangles, and the like. The biscuit can also have varying numbers of layers and can be compressed. Example layered assembly 306 has a browned exterior 304 providing a pretzel-like appearance.

The dimensions of the product are generally sized to provide a product having dimensions suitable for hand held consumption. The length 302 of layered assembly 306 is typically about 0.4 inches to about 4 inches. In some embodiments, layered assembly 306 has a length 302 of about 1.0 to about 3.0 inches, of about 0.5 to about 2.0 inches, of about 2.5 to about 4.0 inches. The width 308 of layered assembly 306 is typically about 0.5 to about 4 inches. In some embodiments, layered assembly 306 has a width 308 of about 1.0 to about 3.0 inches, of about 0.7 to about 1.5 inches, of about 2.0 to about 4.0 inches. In an embodiment, the layered assembly 306 comprises a length 302 of about 0.75 to about 1.5 inches and a width 308 of about 0.75 to about 1.5 inches. In another embodiment, the layered assembly 306 comprises a length 302 of about 2 to about 4 inches and a width 308 of about 0.75 to about 1.5 inches.

The layered assembly 306 can optionally include salt granules or flakes 310 distributed on the browned exterior 304 to further provide the exterior of the product with a pretzel-like appearance. The salt granules or flakes 310 can also contribute to the taste of the product, providing a salty flavor commonly associated with pretzels. The salt granules or flakes can be of differing origin, size, and geometric shape. The uniformity of the flakes or granules 310 on the exterior of the product can vary depending on the method of application and quantity applied to the biscuit. The salt can include sodium salts, potassium salts, magnesium salts, manganese salts, and mixtures thereof. Suitable salts include, but are not limited to, table salt, iodized table salt, kosher table salt, sea salt, fleur de sel, smoked salt, or finishing salt. In embodiments where the salt 310 is desired to contribute to the pretzel-like appearance of the layered assembly 306, the salt 310 typically is selected to have a granular size that would pass through about a U.S.S. 200 mesh sieve to about larger than a U.S.S. 14 Mesh sieve. In some embodiments, other seasonings, for example spices and herbs, may be used in addition to, or in place of, salt.

Example layered assembly 306 also has a browned, pretzel-like exterior surface 304. This surface 304, found on the wheat strands treated with the example salt solution, contains melanoidins. The layered assembly 306 was browned during the baking and/or toasting step 222 in example method 200. In some embodiments, the browning can also be observed in layers closer to the interior.

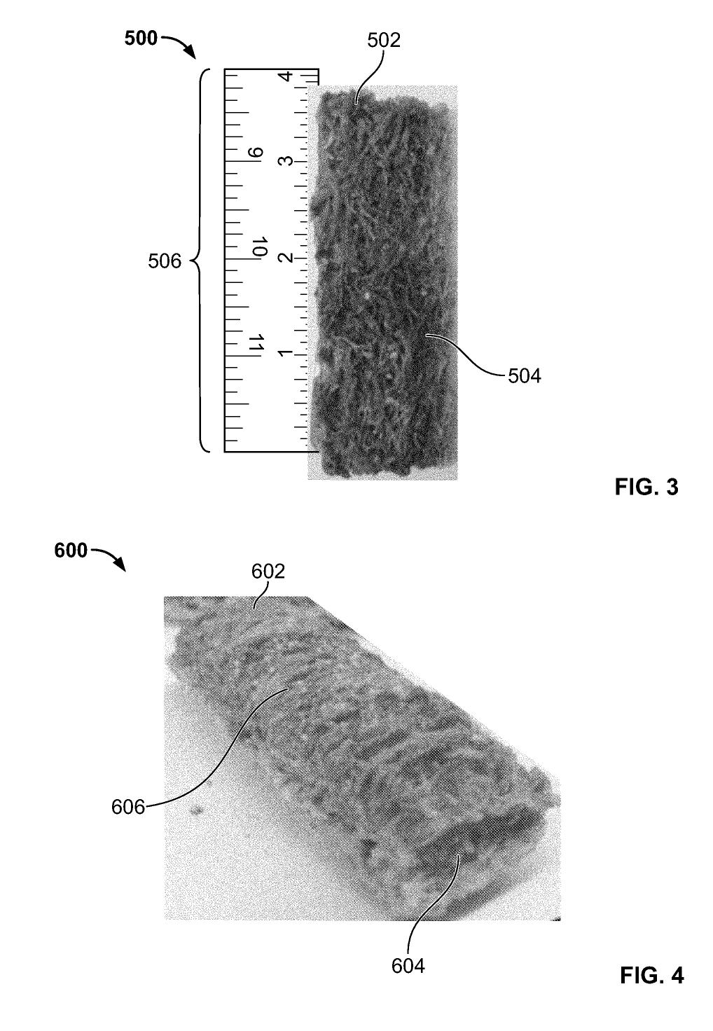

The axial alignment of strands 312 in example layered assembly 306 is also depicted in view 300. In this example, the longitudinal axes of the strands are substantially parallel to others in the same layer. Additionally, the axes are substantially parallel between layers, as shown in more detail in FIG. 2. Also seen in example layered assembly 306 is that the axial alignment of strands 312 is substantially normal to the longitudinal direction of the biscuit. An example biscuit where the axial alignment is substantially parallel to the longitudinal direction is shown in FIG. 3.

FIG. 2 is a cross-sectional view 400 of the layered assembly 306. The layered assembly 306 comprises a plurality of layers 406 and each layer comprises a plurality of shredded whole grain strands 408. The layered assembly 306 has a top whole grain layer 412 defining a first top exterior surface, a bottom whole grain layer 414 defining a second bottom exterior surface, and one or more middle layers. In the embodiment exemplified in FIG. 2, the shredded whole grain strands 408 comprise shredded wheat strands. The strands, however, can be shredded strands obtained from suitable whole grains as described herein. The strands 408 can be oriented substantially parallel to one another as shown in FIG. 2. In other embodiments, the strands are oriented randomly to provide a web, or are layered such that the strands are substantially perpendicular to other strands in the same layer, or are layered such that strands in adjacent layers are substantially perpendicular to each other. Other relative angles (e.g. acute and obtuse) and orientations are possible.

The layered assembly 306 has a height 402 provided by the plurality of layers 406 forming the product. The number of layers can be provided as desired. Typically, the layered assembly 306 comprises about two layers to about fourteen layers. In an embodiment, the biscuit comprises about 4 to about 8 layers. In another embodiment, the biscuit comprises about 10 to about 14 layers. In yet another embodiment, the biscuit comprises about 6 to about 12 layers. In still another embodiment, the biscuit comprises about 4 to about 14 layers.

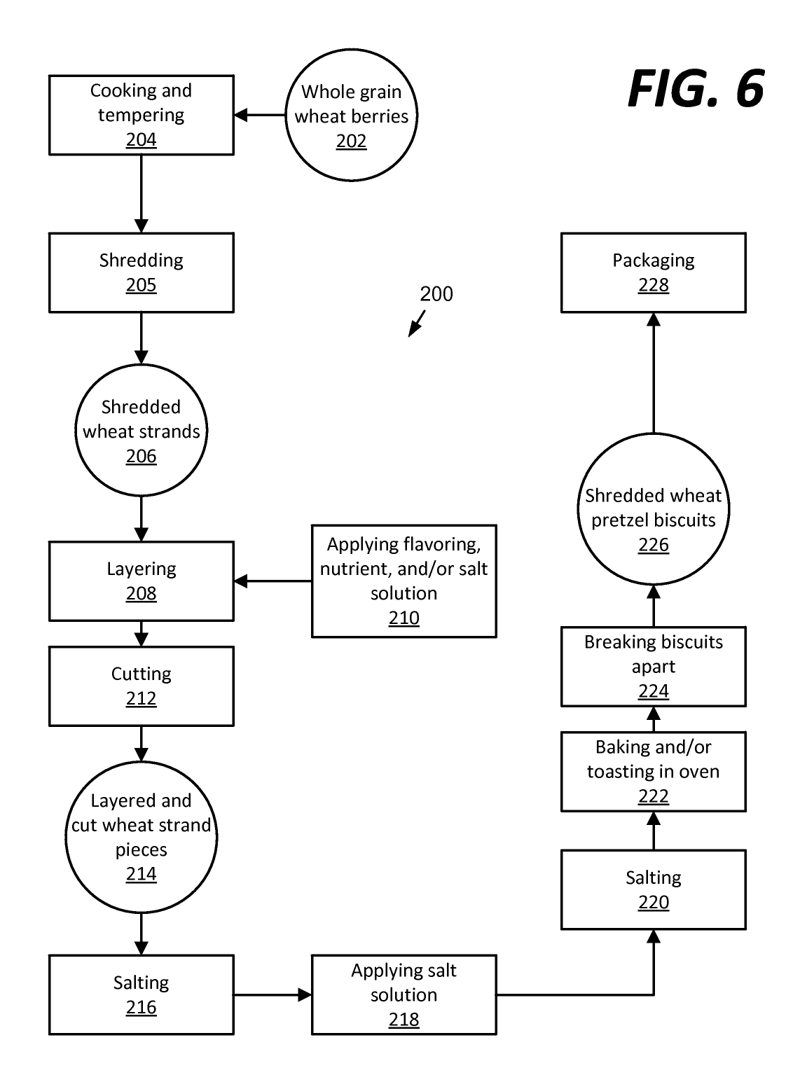

In embodiments, the height 402 of layered assembly 306 is created by folding the shredded whole grain strands to form the layers, as described herein with respect to the exemplary method 200 shown in FIG. 6 for producing the shredded whole grain pretzel product of the disclosure. The folding of layers creates an interior 404 that can contain food particles, flavoring, minerals, vitamins, and combinations thereof as described herein.

Example layered assembly 306 also has a browning profile. In this embodiment, the salt solution was applied topically to one surface. Thus, in a more zoomed-in view, it would be clear that the layers closer to the salt solution applicator have more brown, pretzel-like surface area than those layers deeper in the biscuit. As discussed below with reference to the applying salt solution step 218, however, the browning profile can be reduced or substantially eliminated by using alternate application techniques.

The browning profile can be different between pieces. For instance, depending on the method of salt solution application, salt solution may contact the sides of the pieces on the edges of the conveyor belt, whereas the sides of pieces towards the middle of the conveyor belt may not. As a possible result, pieces on the edges of the conveyor belt can have a different browning profile on their sides than those pieces located near the middle of the conveyor belt.

FIG. 3 is a top view 500 of an example elongated layered assembly 502, produced by example method 200, with shreds aligned substantially longitudinally. In this view 500, the axial alignment of the shreds 504 is labeled. As depicted, the axes of the strands 504 are aligned substantially parallel within each layer and substantially normal to the longitudinal direction. This alignment is termed “longitudinal” for the purposes of this document.

FIG. 4 is a perspective view 600 of an example elongated layered assembly 602 with shreds aligned substantially latitudinally. In this view 600, the interior 604 and axial alignment 606 of example elongated layered assembly 602 is labeled.

As discussed below, flavoring, minerals, vitamins, and food particles, and/or salt solution can be applied during method 200 to the interior 604 or exterior of the biscuit before baking and/or toasting. Example elongated layered assembly 602 has flavoring in the interior.

Also shown in view 600 is the axial alignment of the shreds 606. Example elongated layered assembly 602 has approximately the same dimensions as example elongated layered assembly 502, shown in FIG. 3. However, the shreds are aligned substantially latitudinally, or normal to the longitudinal direction. In other embodiments, example elongated layered assembly 602 is substantially shorter or longer and wider or narrower, as described below with reference to cutting step 212.

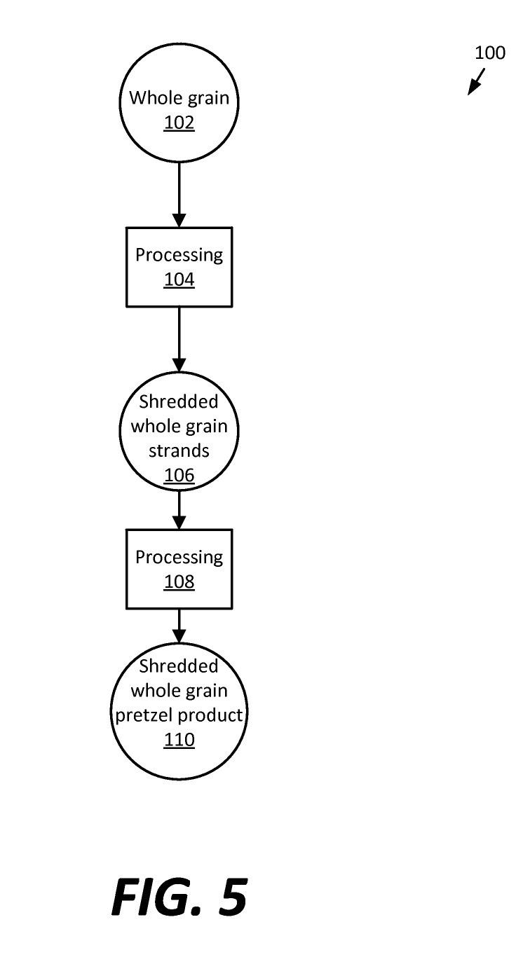

FIG. 5 shows an exemplary method 100 of producing a shredded whole grain pretzel product of the disclosure. The method 100 includes providing whole grain 102, processing 104 the whole grain 102 to provide shredded whole grain strands 106, and processing 108 the shredded whole grain strands to form a shredded whole grain pretzel product 110.

In this embodiment, the process begins with whole grain 102. Whole grain 102 can be berries or kernels. In some embodiments, the whole grain 102 is wheat or corn. In still other embodiments, more than one type of whole grain is used.

Additional processing, not pictured, may be required to provide the harvested whole grain in a process-ready form 102, such as a berry or kernel. For example, the wheat berries are separated from the wheat stalk and de-hulled. The wheat berries 102 can be stored in, for example, a grain surge bin or any storage container commonly used in food processing until processed according to the method 100 shown in FIG. 5.

The whole grain 102 is processed 104 to obtain shredded whole grain strands 106. Processing 104 whole grain 102 to obtain shredded whole grain strands 106 can be performed by conventional methods. Processes for producing shreds of grains, such as wheat, corn, rye, barley, and oats, are described for example in U.S. Pat. No. 8,367,142. For example, in some processes the whole grain 102, such as berries or kernels, is cooked in a vessel comprising heated water and steam and then tempered. After tempering, the cooked and tempered whole grain 102 is then passed through rollers, also known as mills, to shred the cooked and dried berries or kernels into strands. Alternatively, a stamping machine can be used in place of the rollers to produce sheets of strands arranged in a particular configuration. In some embodiments, the product is extruded before stamping. An example embodiment of processing 104 is shown in more detail in FIG. 6, which is described further below.

In some embodiments, the shredded whole grain strands 106 are substantially continuous through the mill rolls. In an embodiment, the shredded whole grain strands have a surface area to volume ratio of from about 66:1 to about 150:1. In some embodiments, the shredded whole grain strands 106 are sheeted in a particular pattern, such as a net or web, where a patterned sheet is on the circumferential surface of the mill.

The shredded whole grain strands 106 after processing 104 generally have a moisture content that is higher than the finished product moisture content. For example, in some embodiments the strands 106 have a moisture content of from about 30% to about 60%; about 43% to about 48%; about 41% to about 46%; or from about 44% to about 47%.

The shredded whole grain strands 106 are then processed to produce the shredded whole grain pretzel product 110. In one embodiment, the processing 108 includes arranging the layers of the pretzel product, applying topical substances, such as vitamins or flavors, applying a salt solution, baking and/or toasting the layers, and separating the individual pretzel products for packaging. An example embodiment of processing 108 is shown in more detail in FIG. 6, which is described further below.

The shredded whole grain pretzel product 110 is the result of processing 108 and can be formed in different geometric configurations. In some embodiments, the pretzel product 110 is a multi-layered assembly having a biscuit form. In some embodiments, the pretzel product 110 has at least two layers of woven or sheeted grain strands. The pretzel product 110 has at least one surface that has pretzel-like flavor. Example embodiments of whole grain pretzel products are shown and described in more detail in FIGS. 1-4 above.

FIG. 6 shows an exemplary method 200 of producing a shredded wheat pretzel product of the disclosure. The method 200 includes whole grain wheat berries 202, cooking and tempering step 204, shredding step 205, shredded wheat strands 206, layering step 208, applying flavoring, vitamins, and/or salt solution step 210, cutting step 212, layered and cut wheat strand pieces 214, salting step 216, applying salt solution step 218, salting step 220, baking and/or toasting in oven step 222, breaking biscuits apart step 224, shredded wheat pretzel biscuits 226, and packaging step 228. In some embodiments of method 200, a series of conveyor belts, shakers, and other process means transport the food product between and through the steps. As used herein, “biscuit” means the product after baking and/or toasting.

In embodiments, the method 200 begins with whole grain wheat berries 202. The whole grain wheat berries 202 can be purchased and the wheat berries cooked, tempered, and shredded as described herein. In some embodiments, one or more processing steps, not pictured, may be performed to obtain the whole grain wheat berries 202 from the harvested wheat. In some embodiments, this earlier processing is performed on-site, off-site, or by a separate entity. The whole grain wheat berries 202 are stored in a vessel suitable for inhibiting degradation and for providing wheat berries to the first cooking step. In some embodiments, additional grains as described herein can be used in addition to, or in place of, the whole grain wheat berries 202.

The whole grain wheat berries 202 are cooked 204. In some embodiments, the berries 202 are cooked in a water bath in step 204. In some embodiments, steam is additionally added to the water bath. In some embodiments, the berries are cooked in a batch cooker vessel with pressure and steam added. The process conditions for cooking whole grain wheat berries can be selected and optimized according to conventional methods.

The cooked berries 202 are then tempered. In this embodiment, cooked berries leave the tempering unit with about 35% to about 55% moisture content; about 43% to about 48%; about 41% to about 46%; or from about 44% to about 47% moisture content. The tempering unit can comprise one, or more than one, tempering units operating in either a batch or continuous mode.

The cooked and tempered berries are then shredded into strands. The shredding process 205 comprises the physical transformation of the still-intact berries into strands. In one embodiment, the cooked and tempered berries pass between two rollers with circumferential grooves in the surface producing shreds or strands of whole wheat. In other embodiments, the rollers have sheets on the circumferential surface in place of grooves or ridges, producing a patterned, substantially continuous sheet of whole wheat.

The shredded wheat strands 206 provided by the shredding step 205 generally have a moisture content that is substantially similar to the moisture content of the cooked and tempered berries, described above. Because the ridges or grooves on the mills or rollers are substantially parallel in the circumferential direction, the strands 206 exit the shredding apparatus in substantially parallel arrangement, with respect to the axial direction of the strands.

The shredded wheat strands 206 are then layered 208 to form a layered assembly. In some embodiments, the strands 206 are layered in succession on a conveyor belt, where each shredding 205 apparatus deposits strands 206 onto the layer passing below. In some embodiments, the layering 208 occurs with a series of mills or rollers, for example, two to twelve mills arranged in succession and positioned over a conveyer belt. In such embodiments, the number of layers can be controlled by the number of mill rolls in operation simultaneously. For example, the final product 226 can include two, three, four, five, six, eight, ten, twelve, or fourteen layers.

The strands 206 can be deposited in different arrangements. For example, in one embodiment a succession of mills or rollers deposit layers of strands onto the conveyor belt that carries the layer from the preceding one or more mills or rollers. In such embodiments, the strands 206 are deposited onto the conveyor belt so that the axial alignment of the deposited layer is substantially parallel to the general axial alignment of the lower layer from the preceding mill or roller. In alternate embodiments, the axial alignment of the layer being deposited onto the conveyor belt is oblique to the layer formed by the preceding mill or roller. Thereby, in these embodiments, the appearance of the layers of the shredded pretzel product can be altered.

In other embodiments, layering 208 comprises the pressing together of one or more sheets after the sheets emerge from shredding 205. In those embodiments, sheets are distinguishable from the strands in that the sheets are substantially continuous in a layer-forming plane, whereas the strands are separate and together comprise one layer.

In some embodiments, layering 208 includes pressing together two or more layers of shredded whole grain strands. The pressing can be accompanied by heat, such as through an iron. The pressing apparatus can also have shapes or designs imprinted thereon so as to impart a particular shape, geometry, or design into the pressed layers. In some embodiments, the resulting biscuit resembles a flat cracker comprised of multiple, compressed layers of whole grain shredded strands.

In some embodiments, the layers exiting the series of mills or rollers can be folded one or more times. In such embodiments, the number of layers of the final product are doubled with each folding. For example, if three mills are used for shredding 205, then the resulting three layers when folded once will comprise a six-layered biscuit. The folding step can be performed by any suitable apparatus or process known in the art. The folding process is also known as layering the strands. In some embodiments, flavoring and/or food particles are deposited onto the layers, which are subsequently folded over, thereby “sandwiching” the flavoring or food particles in the middle of the biscuit.

Generally, the layers exiting the layering step 208 are substantially continuous. The width of the moving layer, where width is defined as the direction substantially normal to the conveyor belt's direction of movement, is generally from about one foot to about six feet across. In some embodiments, the width of the layers is from about 1.25 ft to about 3 ft; from about 0.75 ft to about 1.75 ft; from about 3 ft to about 6.5 ft; or from about 1.5 ft to about 2 ft across.

In some embodiments, layering 208 also includes applying flavoring, minerals, vitamins, and/or salt solution 210. Applying flavoring, minerals, vitamins, and/or salt solution to each layer can result in a more uniform application, as between layers, than by applying, using some methods such as spraying, after the layers have been assembled. In some embodiments, the flavoring is a seasoning including one or more flavors, for example, herbs, spices, garlic, salt, pepper, honey, mustard, onion, bacon, cheddar cheese, buffalo wing, jalapeno, peanut butter, sugar, cinnamon, parmesan, sesame seed, chipotle, natural flavors, artificial flavors, etc. In some embodiments, flavoring is food or food particulates, such as chocolate chips, dried fruit, ground nuts, or an application of peanut butter. Step 210 can include from about 0 wt. % to about 100 wt. %, from about 0 wt. % to about 70 wt. %, from about 20 wt. % to about 50 wt. % and from about 10 wt. % to about 15 wt. % of the flavoring and particulate.

A dusting agent can be added to one or more layers to fortify the whole grain pretzel production of the disclosure with vitamins and/or minerals. The dusting agent can be any dry material suitable for consumption which coats the aggregated clusters and reduces their stickiness. Examples of suitable dusting agents include calcium carbonate, ferric orthophosphate, and microcrystalline cellulose. The dusting agent can include one or more vitamins or minerals. Examples of vitamins include, but are not limited to, vitamin A, vitamin B5, vitamin B6, vitamin B12, vitamin C, biotin, folate, niacin, riboflavin, thiamine, and vitamin E in the form of tocopherols. Examples of minerals include, but are not limited, calcium, iron, potassium, magnesium, zinc. In an embodiment, the whole grain pretzel product includes from about 0% to about 4% dusting agent by weight.

Inclusions can be added to one or more layers to provide additional flavoring and/or texture to the product. Examples of inclusions include carbohydrate-based inclusions, fat-based inclusions, oil-based inclusions, vegetables, meat (e.g., bacon, jerky), dehydrated fruit, chocolate chips, coconut, nuts, additional grain pieces, confections, and infused fruit. Examples of dehydrated fruit include apples, raisins, peaches, blueberries, cranberries, pineapple, strawberries, figs, prunes, dates, and the like. Examples of nuts include walnuts, pecans, almonds, peanuts, cashews, and the like. In an embodiment, the whole grain pretzel product comprises from about 0% to about 30% inclusions by weight.

In some embodiments, a salt solution is applied to each layer before layering 205. The salt solution and application of the salt solution is described in more detail below with reference to step 218.

The layered assembly formed by the layering step 208, is then cut 212 into pieces. The pieces generally have a biscuit form as described herein. In some embodiments, cutting the layers 212 substantially or completely separates the mostly continuous sheet moving on the conveyor belt into pieces. In some embodiments, the layers are cut in the direction running parallel to the movement of the conveyor belt (“longitudinal cutting”). For example, the cutting 212 may be effectuated by a series of sharpened blades arranged substantially parallel to the motion of the conveyor belt, such that the layers exit the cutting 212 are divided into substantially uniform widths. These cutting blades can be fixed and the sheets forced through the blades. In other embodiments, the blades can be lowered or raised into contact with the sheets. The cutting process 212 may also include crimping. Other cutting means and configurations are possible.

In embodiments where the strands are axially arranged substantially parallel within each layer and with respect to adjacent layers, the layers are cut substantially parallel to the axial alignment of the strands or substantially normal to the axial alignment of the strands.

In some embodiments, the layers are cut in a direction substantially normal to the direction of the conveyor belt's movement (“latitudinal cutting”). Cutting in the latitudinal direction can be done in place of, or in addition to, longitudinal cutting. In some embodiments, one or more sharpened blades positioned substantially normal to the conveyor belt's movement effectuate the latitudinal cutting. For example, in one embodiment, the latitudinally-disposed blade, or blades, is attached to a lowering apparatus, where the lowering apparatus is programmed to deliver the blade or blades into the passing layers such that the layers are divided uniformly in the latitudinal direction. Other configurations are possible.

In some embodiments, cutting 212 separates each piece completely from its latitudinal and longitudinal neighbors in separate pieces. In other embodiments, cutting 212 substantially separates the strands from their latitudinal and longitudinal neighbors in separate pieces, but the pieces 214 move along the conveyor belt substantially as a continuous sheet. For example, in an embodiment having twelve layers, the cutting step 212 may penetrate ten of the twelve layers—for example the five layers extending from the top surface towards the middle and the five layers extending from the bottom surface extending towards the middle. Alternatively, in some embodiments a cutting apparatus separates all but the bottom one or two layers closest to the conveyor belt. In these embodiments, the pieces are not completely separated from their latitudinal and longitudinal neighbors until the breaking step 224.

The layered and cut wheat strand pieces 214 exit the layering 208 and cutting 212 steps in example method 200. In some embodiments, the pieces 214 are divided in the longitudinal direction so that each piece is from about 0.4 inch to about 4 inches in length; from about 1 inch to about 1.25 inches; or from about 0.5 inch to about 1 inch in length. In some embodiments, the pieces 214 are divided in the latitudinal direction such that each piece is from about 0.5 inch to about 4 inches in width; from about 1 inch to about 1.25 inches; or from about 0.75 inch to about 1 inch in width.

The strands comprising the pieces 214 are from about 0.1 inch to about 2 inches; about 0.4 inch to about 1.5 inch; or about 0.5 inch to about 1 inch in length.

In some embodiments, the moisture content of the pre-baked biscuits exiting step 212 has not substantially changed from the tempered wheat moisture. A small amount of moisture can be lost because of, for example, the work put into the product during milling. In some embodiments, the moisture content of the pre-baked biscuits exiting step 212 is from about 35% to about 50% moisture.

The layered and cut wheat strand pieces 214 are then salted. Salting 216 can be effectuated by depositing onto the layers at different rates and at different coating densities. The salt can be of different geometric shapes, such as flakes or cubes. Additionally, the salt can be of a coarse grind or of a fine grind. Other salts and salt shapes are possible. The salt can include sodium salts, potassium salts, magnesium salts, manganese salts, and mixtures thereof. Suitable salts used in salting 216 include, but are not limited to, table salt, iodized table salt, kosher table salt, sea salt, fleur de sel, smoked salt, or finishing salt. Salting 216 can also include, in some embodiments, seasonings, herbs, and/or spices.

In some embodiments, salting 216 occurs earlier in the process. For example, the shredded wheat strands 206 can be salted after shredding 206. In other embodiments, the layers are salted after layering 208 but before cutting 212. In some embodiments, salting 216 occurs after both the shredding 205 and the layering 208 steps.

After salting 216, a salt solution is applied 218 to the pieces. Suitable salt solutions include, but are not limited to, sodium hydroxide, sodium bicarbonate, potassium hydroxide, potassium carbonate, potassium bicarbonate, monocalcium phosphate, sodium aluminum sulfate, sodium acid pyrophosphate, baking powder, or mixtures thereof in an aqueous medium, such as water. In some embodiments, the salt solution 218 can be applied to pieces after pre-drying the pieces 214 but before toasting or baking the pieces.

In some embodiments, the salt solution comprises sodium hydroxide or lye. In such embodiments, the concentration of sodium hydroxide is from about 1% to about 10% by weight; from about 5% to about 8%; from about 3% to about 6%; or from about 2% to about 7% by weight. In other embodiments, the salt solution comprises sodium bicarbonate or baking soda. In such embodiments, the concentration of sodium bicarbonate is from about 5% to about 15% by weight; from about 7% to about 11%; or from about 8% to about 13% by weight.

The salt solution can applied to the layered and cut pieces 214 using various methods, including but not limited to spraying, brushing, misting, pouring, dunking, immersing, submerging, and the like. Generally the salt solution is applied to substantially the entire exterior surface of the cut pieces. In an embodiment, the salt solution is sprayed onto the pieces 214 as they pass one or more nozzles. In some embodiments, the solution is sprayed or misted onto both the top and bottom layers of the pieces 214.

In spray application embodiments, the salt solution substantially coats the surface of the strands on the outermost layer facing the spraying apparatus. In these embodiments, each subsequent layer towards the middle of the piece has marginally less salt solution applied to the surface of the strands than the layer closer to the spraying apparatus. Thus, a cross-sectional salt concentration, such as sodium hydroxide or sodium bicarbonate, profile exists in some embodiments.

In some embodiments, the pieces are submerged, or dunked, into a bath of the salt solution. The penetration of the salt solution into one of more of the middle layers of the layered assembly can be controlled by the length of time the pieces are submersed in the base. In these embodiments, the pieces are typically submersed in the bath for about 1 second to about 1 minute; for about 20 seconds to about 50 seconds; for about 25 seconds to about 40 seconds; or for about 3 seconds to about 15 seconds. In some embodiments, dunking the pieces 214 eliminates or greatly reduces the cross-sectional salt concentration profile, between layers that were submerged in the salt solution bath, than is observed in some of the spray application embodiments.

In some embodiments, the salt solution 218 is applied to the pieces by pouring the salt solution onto the pieces. Pouring, in some embodiments, results in a smaller differential in the concentration profile than the spraying method.

Pretzels traditionally have a characteristic dusting of large salt flakes on their surface. In method 200, the pieces can be optionally salted 220 after applying the salt solution 218. To further mimic the pretzel-like appearance of the product, the salt is generally a coarse salt. In an embodiment, salt has a particle size of about through a U.S.S. 200 Mesh sieve to about through a U.S.S. 14 Mesh sieve. Salting 220 can be performed in addition to salting 216 or in place of salting 216.

Salting 220 after applying the salt solution 218 has better adhesion to the biscuit and thus better performance and yield throughout the remainder of the processing and packaging system. Flavor release is also improved as the salt or seasoning is topical and the salt solution is not encasing or coating the salt or seasoning. In some embodiments, salting 220 occurs later in the process, for example, after baking. In still other embodiments, the salting step or steps are omitted.

After the pieces have been salted and/or a salt solution applied, the pieces are baked and/or toasted in an oven 222. In some embodiments, the layered and cut wheat strand pieces 214, pass through an oven. In some embodiments, the oven is a multi-zone oven wherein each zone is capable of different operating temperatures and air movement settings. In some embodiments, the pieces 214 pass through a toasting apparatus after passing through one or more oven zones.

Heat provided by the baking and/or toasting 222 induces the Maillard reaction, promotes adherence between the shredded whole grain strands, bakes the interior of the strands, and creates a browned, toasted and crispy exterior on the strands treated with the salt solution. The presence and extent of the aforementioned results of step 222 can be modified by the temperature, the type of drying or toasting apparatus, the number of heating or toasting zones the pieces 214 pass through, concentration of salt in the salt solution, and pH of the salt solution.

Types of ovens used in this step include rotary ovens, traveling tray ovens (single-lap or multiple-lap), tunnel ovens, impingement ovens, belt ovens, gas-fired, or steam heated ovens. Typical operating temperatures in each of the zones are typically between about 250 degrees Fahrenheit to 550 degrees Fahrenheit. In another embodiment, operating temperatures in each zone are between about 300 degrees Fahrenheit and about 525 degrees Fahrenheit. During baking and/or toasting 222, the surfaces of the wheat strands sprayed with or coated with the salt solution at step 218 undergo nonenzymatic browning as described herein. The Maillard browning reaction provides the browned exterior, which comprises melanoidins formed during nonenzymatic browning that contribute to the pretzel-like flavor of the product. The rate of nonenzymatic browning can be controlled, for example, by the pH of the salt solution, type of sugar involved in the carbonyl-amine reactions, baking temperature, and/or moisture content of the product, thereby controlling the intensity of pretzel-like flavor and color at the surface of the strands.

As discussed above, the amount of browning can also be controlled by the salt solution application steps 210 and 218. In some embodiments, only the top whole grain layer and/or the bottom whole grain layer have a substantial amount of nonenzymatic browning on the exterior surfaces of the wheat strands. In other embodiments, the two or three layers closest to the top and/or bottom whole grain layers also have a substantial amount of browning on the exterior surfaces of the wheat strands. In an embodiment, the nonenzymatic browning portion formed by the Maillard reaction comprises at least 50 percent of the exterior surfaces of the product. In another embodiment, the nonenzymatic browning portion formed by the Maillard reaction comprises at least 75 percent of the exterior surfaces of the product. In yet another embodiment, the nonenzymatic browning portion formed by the Maillard reaction comprises at least 90 percent of the exterior surfaces of the product.

The baked and/or toasted biscuits are then broken apart 224 in example method 200. As the pieces may not have been fully severed in cutting step 212, or the baking and/or toasting in oven step 222 may have caused adjacent pieces to bind, the breaking step 224 separates each piece from its adjacent neighbors in the process. Breaking biscuits apart 224 can be accomplished by any means known in the art, such as, for example, applying pressure via a perforated sheet on rollers. Other techniques are known and can be utilized.

Shredded wheat pretzel biscuits 226 emerge from the breaking step 224 in method 200. At this stage, the biscuits 226 are individually separated. In some embodiments, the separated biscuits 226 are sent to a bulk storage unit, not pictured, after breaking step 224 and before packaging 228. In some embodiments, the biscuits 226 are sent from the breaking step 224 to the packaging step 228. Packaging 228 assembles the biscuits into various forms for retail sale, for example, individual packages of biscuits, boxes containing individual packages, or a bag or pouch containing a plurality of biscuits. Other commercial embodiments are possible. Means for packaging 228 are well known in the art.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A baked food product comprising a layered assembly, the assembly comprising:
a top whole grain layer and a bottom whole grain layer,
wherein each whole grain layer comprises a plurality of shredded whole grain strands;
a first exterior surface defined by the top whole grain layer; and
a second exterior surface defined by the bottom whole grain layer;
wherein one or more of the exterior surfaces is treated with a salt solution and the treated surface comprises a nonenzymatic browning portion formed by a Maillard reaction.

2. The baked food product of claim 1, wherein the salt solution increases the pH of the exterior surface and induces the Maillard reaction at the treated surface.

3. The baked food product of claim 1, wherein the browned portion comprises melanoidins.

4. The baked food product of claim 1, wherein the salt solution comprises sodium hydroxide or sodium bicarbonate.

5. The baked food product of claim 1, further comprising one or more middle whole grain layers.

6. The baked food product of claim 1, wherein the layered assembly is substantially shaped as a rectangular prism, the layered assembly having a width from about 0.7 to about 1 inch, a length from about 0.5 to about 3.5 inches, and a height from about 0.5 to about 1.5 inches.

7. The baked food product of claim 1, comprising four to fourteen shredded wheat layers.

8. The baked food product of claim 1, wherein the shredded whole grain strands of each layer are substantially uniformly arranged.

9. The baked food product of claim 1, comprising two layers of sheeted strands.

10. The baked food product of claim 1, wherein the baked food product is fortified with vitamins and/or minerals.

11. The baked food product of claim 1, wherein the top whole grain layer has a plurality of salt particles deposited thereon.

12. The baked food product of claim 1, wherein each shredded whole grain strand has a surface area to volume ratio of from about 66:1 to about 150:1.

13. The baked food product of claim 1, wherein the whole grain comprises wheat.

14. The baked food product of claim 4, wherein the salt solution comprises about 1% to about 15% by weight sodium hydroxide in water.

15. The baked food product of claim 4, wherein the salt solution comprises about 4% to about 20% by weight sodium bicarbonate in water.

16. The baked food product of claim 1, wherein the baked food product is in a biscuit form.

17. The baked food product of claim 1, wherein one or more whole grain layers are compressed before baking.

18. A method of producing a baked food product according to claim 1, comprising:
producing a shredded whole grain strand;
producing a layer comprising a plurality of shredded whole grain strands;
layering the layers of shredded whole grain strands to form an assembly comprising a plurality of layers of shredded whole grain strands;
applying a salt solution to the layered assembly; and
baking the assembly treated with the salt solution.

19. The method of claim 18, wherein the salt solution comprises sodium hydroxide or sodium bicarbonate.

20. The method of claim 19, wherein the salt solution comprises about 1% to about 15% by weight sodium hydroxide in water.

21. The method of claim 20, wherein the salt solution comprises about 4% to about 20% by weight sodium bicarbonate in water.

22. The method of claim 21, wherein the plurality of layers are formed by successive deposition of the shredded whole grain strands.

23. The method of claim 22, wherein the layers are produced by a folding step.

24. The method of claim 19, wherein the surfaces of the layered assembly treated with salt solution undergo nonenzymatic browning during baking.

25. The method of claim 19, wherein the salt solution increases the pH of the surfaces of the layered assembly treated with the salt solution and the baking induces a Maillard reaction at the surfaces treated with the salt solution.

26. The method of claim 19, wherein the layered assembly comprises a biscuit form.

27. The baked food product of claim 19, wherein the layered assembly is compressed before baking.
